(19) United States
(12) Patent Application Publication
(10) Pub. No.: US 2023/0105758 A1
(43) Pub. Date: Apr. 6, 2023

(54) MAC CE WITH SPATIAL RELATION INFORMATION FOR SRS RESOURCES ACROSS A LIST OF CELLS

(71) Applicants: Ruiming ZHENG, San Diego, CA (US); Linhai HE, San Diego, CA (US); Yan ZHOU, San Diego, CA (US); Tao LUO, San Diego, CA (US); QUALCOMM Incorporated, San Diego, CA (US)

(72) Inventors: Ruiming ZHENG, Beijing (CN); Linhai HE, San Diego, CA (US); Yan ZHOU, San Diego, CA (US); Tao LUO, San Diego, CA (US)

(21) Appl. No.: 17/904,492

(22) PCT Filed: Apr. 3, 2020
(86) PCT No.: PCT/CN20/83168

§ 371 Date: Aug. 18, 2022

(51) Int. Cl. H04L 5/00

(52) U.S. Cl. CPC H04L 5/0051

(57) ABSTRACT

In an aspect, a BS obtains spatial relation information to be applied by a UE with respect to at least one set of SRS resources associated with at least one SRS identifier across all cells in a list of cells. The BS transmits, to the UE, a MAC CE including the spatial relation information, the at least one SRS identifier, and an indication of the list of cells. The UE receives the MAC CE and applies the spatial relation information with respect to at least one set of SRS resources associated with the at least one SRS identifier across all cells in the list of cells.

### BACKGROUND OF THE DISCLOSURE

### 1. Field of the Disclosure

Aspects of the disclosure relate generally to a media access control (MAC) command element (CE) that includes spatial relation information for a sounding reference signal (SRS) across a list of cells.

### 2. Description of the Related Art

Wireless communication systems have developed through various generations, including a first-generation analog wireless phone service (1G), a second-generation (2G) digital wireless phone service (including interim 2.5G networks), a third-generation (3G) high speed data, Internet-capable wireless service and a fourth-generation (4G) service (e.g., LTE or WiMax). There are presently many different types of wireless communication systems in use, including cellular and personal communications service (PCS) systems. Examples of known cellular systems include the cellular Analog Advanced Mobile Phone System (AMPS), and digital cellular systems based on code division multiple access (CDMA), frequency division multiple access (FDMA), time division multiple access (TDMA), the Global System for Mobile access (GSM) variation of TDMA, etc.

A fifth generation (5G) wireless standard, referred to as New Radio (NR), enables higher data transfer speeds, greater numbers of connections, and better coverage, among other improvements. The 5G standard, according to the Next Generation Mobile Networks Alliance, is designed to provide data rates of several tens of megabits per second to each of tens of thousands of users, with 1 gigabit per second to tens of workers on an office floor. Several hundreds of thousands of simultaneous connections should be supported in order to support large wireless deployments. Consequently, the spectral efficiency of 5G mobile communications should be significantly enhanced compared to the current 4G standard. Furthermore, signaling efficiencies should be enhanced and latency should be substantially reduced compared to current standards.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

An aspect is directed to a method of operating a user equipment (UE), comprising receiving a media access control (MAC) command element (CE) including spatial relation information, at least one sounding reference signal (SRS) identifier, and an indication of a list of cells, and applying, in response to the MAC CE, the spatial relation information with respect to at least one set of SRS resources associated with the at least one SRS identifier across all cells in the list of cells.

Another aspect is directed to a method of operating a base station (BS), comprising obtaining spatial relation information to be applied by a user equipment (UE) with respect to at least one set of sounding reference signal (SRS) resources associated with at least one SRS identifier across all cells in a list of cells, and transmitting, to the UE, a media access control (MAC) command element (CE) including the spatial relation information, the at least one SRS identifier, and an indication of the list of cells.

Another aspect is directed to a user equipment (UE), comprising means for receiving a media access control (MAC) command element (CE) including spatial relation information, at least one sounding reference signal (SRS) identifier, and an indication of a list of cells, and means for applying, in response to the MAC CE, the spatial relation information with respect to at least one set of SRS resources associated with the at least one SRS identifier across all cells in the list of cells.

Another aspect is directed to a base station (BS), comprising means for obtaining spatial relation information to be applied by a user equipment (UE) with respect to at least one set of sounding reference signal (SRS) resources associated with at least one SRS identifier across all cells in a list of cells, and means for transmitting, to the UE, a media access control (MAC) command element (CE) including the spatial relation information, the at least one SRS identifier, and an indication of the list of cells

Another aspect is directed to a user equipment (UE), comprising a memory, at least one communications interface, and at least one processor communicatively coupled to the memory, the at least one communications interface, the at least one processor configured to receive a media access control (MAC) command element (CE) including spatial relation information, at least one sounding reference signal (SRS) identifier, and an indication of a list of cells, and apply, in response to the MAC CE, the spatial relation information with respect to at least one set of SRS resources associated with the at least one SRS identifier across all cells in the list of cells.

Another aspect is directed to a base station (BS), comprising a memory, at least one communications interface, and at least one processor communicatively coupled to the memory, the at least one communications interface, the at least one processor configured to obtain spatial relation information to be applied by a user equipment (UE) with respect to at least one set of sounding reference signal (SRS) resources associated with at least one SRS identifier across all cells in a list of cells, and transmit, to the UE, a media access control (MAC) command element (CE) including the spatial relation information, the at least one SRS identifier, and an indication of the list of cells

Another aspect is directed to a non-transitory computer-readable medium containing instructions stored thereon, which, when executed by a user equipment (UE), cause the UE to perform operations, the instructions comprising at least one instruction to cause the UE to receive a media access control (MAC) command element (CE) including spatial relation information, at least one sounding reference signal (SRS) identifier, and an indication of a list of cells, and at least one instruction to cause the UE to apply, in response to the MAC CE, the spatial relation information with respect to at least one set of SRS resources associated with the at least one SRS identifier across all cells in the list of cells.

Another aspect is directed to a non-transitory computer-readable medium containing instructions stored thereon, which, when executed by a base station (BS), cause the BS to perform operations, the instructions comprising at least one instruction to cause the BS to obtain spatial relation information to be applied by a user equipment (UE) with respect to at least one set of sounding reference signal (SRS) resources associated with at least one SRS identifier across all cells in a list of cells, and at least one instruction to cause the BS to transmit, to the UE, a media access control (MAC) command element (CE) including the spatial relation information, the at least one SRS identifier, and an indication of the list of cells.

Other objects and advantages associated with the aspects disclosed herein will be apparent to those skilled in the art based on the accompanying drawings and detailed description.

### BRIEF DESCRIPTION OF THE DRAWINGS

The accompanying drawings are presented to aid in the description of various aspects of the disclosure and are provided solely for illustration of the aspects and not limitation thereof.

FIG. 1 illustrates an exemplary wireless communications system, according to various aspects.

FIGS. 2A and 2B illustrate example wireless network structures, according to various aspects.

FIG. 3 is a block diagram illustrating an exemplary UE, according to various aspects.

FIG. 4 is a diagram illustrating an example of a frame structure for use in a wireless telecommunications system according to an aspect of the disclosure.

FIG. 5 illustrates an example configuration of a Rel. 15 SP SRS Activation/Deactivation MAC CE.

FIG. 6 illustrates an exemplary method of wireless communication, according to aspects of the disclosure.

FIG. 7 illustrates an exemplary method of wireless communication, according to aspects of the disclosure.

FIG. 8 illustrates an example configuration of a SRS Activation/Deactivation MAC CE 800 in accordance with an embodiment of the disclosure.

FIG. 9 illustrates an example configuration of a SRS Activation/Deactivation MAC CE in accordance with another embodiment of the disclosure.

FIG. 10 illustrates an example configuration of a SRS Activation/Deactivation MAC CE in accordance with another embodiment of the disclosure.

FIG. 11 illustrates an example configuration of a SRS Activation/Deactivation MAC CE in accordance with another embodiment of the disclosure.

### DETAILED DESCRIPTION

Aspects of the disclosure are provided in the following description and related drawings directed to various examples provided for illustration purposes. Alternate aspects may be devised without departing from the scope of the disclosure. Additionally, well-known elements of the disclosure will not be described in detail or will be omitted so as not to obscure the relevant details of the disclosure.

The words “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage or mode of operation.

Those of skill in the art will appreciate that the information and signals described below may be represented using any of a variety of different technologies and techniques. For example, data, instructions, commands, information, signals, bits, symbols, and chips that may be referenced throughout the description below may be represented by voltages, currents, electromagnetic waves, magnetic fields or particles, optical fields or particles, or any combination thereof, depending in part on the particular application, in part on the desired design, in part on the corresponding technology, etc.

Further, many aspects are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, the sequence(s) of actions described herein can be considered to be embodied entirely within any form of non-transitory computer-readable storage medium having stored therein a corresponding set of computer instructions that, upon execution, would cause or instruct an associated processor of a device to perform the functionality described herein. Thus, the various aspects of the disclosure may be embodied in a number of different forms, all of which have been contemplated to be within the scope of the claimed subject matter. In addition, for each of the aspects described herein, the corresponding form of any such aspects may be described herein as, for example, “logic configured to” perform the described action.

As used herein, the terms “user equipment” (UE) and “base station” are not intended to be specific or otherwise limited to any particular Radio Access Technology (RAT), unless otherwise noted. In general, a UE may be any wireless communication device (e.g., a mobile phone, router, tablet computer, laptop computer, tracking device, wearable (e.g., smartwatch, glasses, augmented reality (AR)/virtual reality (VR) headset, etc.), vehicle (e.g., automobile, motorcycle, bicycle, etc.), Internet of Things (IoT) device, etc.) used by a user to communicate over a wireless communications network. A UE may be mobile or may (e.g., at certain times) be stationary, and may communicate with a Radio Access Network (RAN). As used herein, the term “UE” may be referred to interchangeably as an “access terminal” or “AT,” a “client device,” a “wireless device,” a “subscriber device,” a “subscriber terminal,” a “subscriber station,” a “user terminal” or UT, a “mobile terminal,” a “mobile station,” or variations thereof. Generally, UEs can communicate with a core network via a RAN, and through the core network the UEs can be connected with external networks such as the Internet and with other UEs. Of course, other mechanisms of connecting to the core network and/or the Internet are also possible for the UEs, such as over wired access networks, wireless local area network (WLAN) networks (e.g., based on IEEE 802.11, etc.) and so on.

A base station may operate according to one of several RATs in communication with UEs depending on the network in which it is deployed, and may be alternatively referred to as an access point (AP), a network node, a NodeB, an evolved NodeB (eNB), a New Radio (NR) Node B (also referred to as a gNB or gNodeB), etc. In addition, in some systems a base station may provide purely edge node signaling functions while in other systems it may provide additional control and/or network management functions. A communication link through which UEs can send signals to a base station is called an uplink (UL) channel (e.g., a reverse traffic channel, a reverse control channel, an access channel, etc.). A communication link through which the base station can send signals to UEs is called a downlink (DL) or forward link channel (e.g., a paging channel, a control channel, a broadcast channel, a forward traffic channel, etc.). As used herein the term traffic channel (TCH) can refer to either an UL/reverse or DL/forward traffic channel.

The term “base station” may refer to a single physical transmission point or to multiple physical transmission points that may or may not be co-located. For example, where the term “base station” refers to a single physical transmission point, the physical transmission point may be an antenna of the base station corresponding to a cell of the base station. Where the term “base station” refers to multiple co-located physical transmission points, the physical transmission points may be an array of antennas (e.g., as in a multiple-input multiple-output (MIMO) system or where the base station employs beamforming) of the base station. Where the term “base station” refers to multiple non-co-located physical transmission points, the physical transmission points may be a distributed antenna system (DAS) (a network of spatially separated antennas connected to a common source via a transport medium) or a remote radio head (RRH) (a remote base station connected to a serving base station). Alternatively, the non-co-located physical transmission points may be the serving base station receiving the measurement report from the UE and a neighbor base station whose reference RF signals the UE is measuring.

An “RF signal” comprises an electromagnetic wave of a given frequency that transports information through the space between a transmitter and a receiver. As used herein, a transmitter may transmit a single “RF signal” or multiple “RF signals” to a receiver. However, the receiver may receive multiple “RF signals” corresponding to each transmitted RF signal due to the propagation characteristics of RF signals through multipath channels. The same transmitted RF signal on different paths between the transmitter and receiver may be referred to as a “multipath” RF signal.

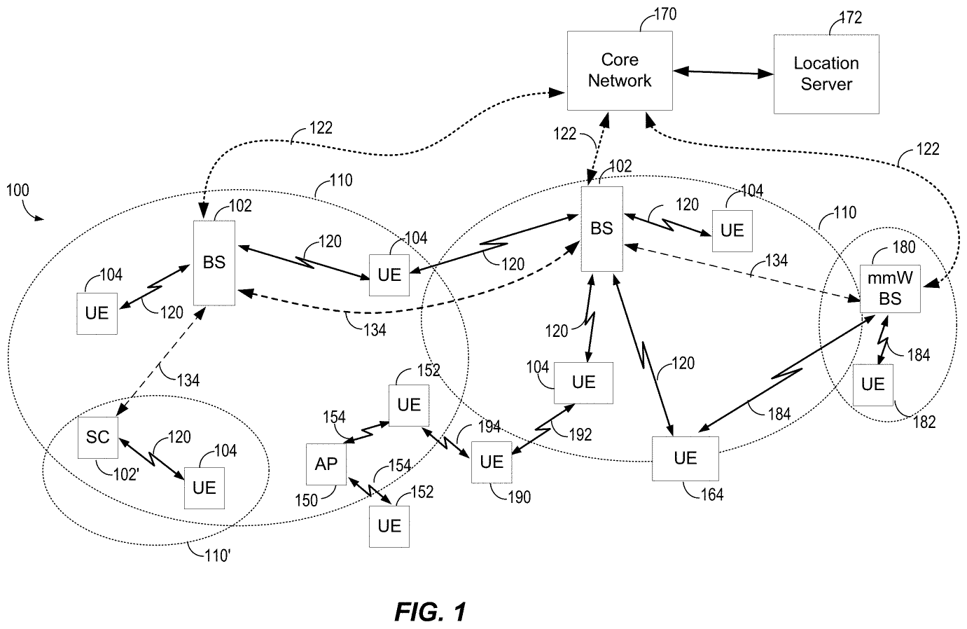

According to various aspects, FIG. 1 illustrates an exemplary wireless communications system 100. The wireless communications system 100 (which may also be referred to as a wireless wide area network (WWAN)) may include various base stations 102 and various UEs 104. The base stations 102 may include macro cell base stations (high power cellular base stations) and/or small cell base stations (low power cellular base stations). In an aspect, the macro cell base station may include eNBs where the wireless communications system 100 corresponds to an LTE network, or gNBs where the wireless communications system 100 corresponds to a 5G network, or a combination of both, and the small cell base stations may include femtocells, picocells, microcells, etc.

The base stations 102 may collectively form a RAN and interface with a core network 170 (e.g., an evolved packet core (EPC) or next generation core (NGC)) through backhaul links 122, and through the core network 170 to one or more location servers 172. In addition to other functions, the base stations 102 may perform functions that relate to one or more of transferring user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, RAN sharing, multimedia broadcast multicast service (MBMS), subscriber and equipment trace, RAN information management (RIM), paging, positioning, and delivery of warning messages. The base stations 102 may communicate with each other directly or indirectly (e.g., through the EPC/NGC) over backhaul links 134, which may be wired or wireless.

The base stations 102 may wirelessly communicate with the UEs 104. Each of the base stations 102 may provide communication coverage for a respective geographic coverage area 110. In an aspect, one or more cells may be supported by a base station 102 in each coverage area 110. A “cell” is a logical communication entity used for communication with a base station (e.g., over some frequency resource, referred to as a carrier frequency, component carrier, carrier, band, or the like), and may be associated with an identifier (e.g., a physical cell identifier (PCID), a virtual cell identifier (VCID)) for distinguishing cells operating via the same or a different carrier frequency. In some cases, different cells may be configured according to different protocol types (e.g., machine-type communication (MTC), narrowband IoT (NB-IoT), enhanced mobile broadband (eMBB), or others) that may provide access for different types of UEs. In some cases, the term “cell” may also refer to a geographic coverage area of a base station (e.g., a sector), insofar as a carrier frequency can be detected and used for communication within some portion of geographic coverage areas 110.

While neighboring macro cell base station 102 geographic coverage areas 110 may partially overlap (e.g., in a handover region), some of the geographic coverage areas 110 may be substantially overlapped by a larger geographic coverage area 110. For example, a small cell base station 102′ may have a coverage area 110′ that substantially overlaps with the coverage area 110 of one or more macro cell base stations 102. A network that includes both small cell and macro cell base stations may be known as a heterogeneous network. A heterogeneous network may also include home eNBs (HeNBs), which may provide service to a restricted group known as a closed subscriber group (CSG).

The communication links 120 between the base stations 102 and the UEs 104 may include UL (also referred to as reverse link) transmissions from a UE 104 to a base station 102 and/or downlink (DL) (also referred to as forward link) transmissions from a base station 102 to a UE 104. The communication links 120 may use MIMO antenna technology, including spatial multiplexing, beamforming, and/or transmit diversity. The communication links 120 may be through one or more carrier frequencies. Allocation of carriers may be asymmetric with respect to DL and UL (e.g., more or less carriers may be allocated for DL than for UL).

The wireless communications system 100 may further include a wireless local area network (WLAN) access point (AP) 150 in communication with WLAN stations (STAs) 152 via communication links 154 in an unlicensed frequency spectrum (e.g., 5 GHz). When communicating in an unlicensed frequency spectrum, the WLAN STAs 152 and/or the WLAN AP 150 may perform a clear channel assessment (CCA) prior to communicating in order to determine whether the channel is available.

The small cell base station 102′ may operate in a licensed and/or an unlicensed frequency spectrum. When operating in an unlicensed frequency spectrum, the small cell base station 102′ may employ LTE or 5G technology and use the same 5 GHz unlicensed frequency spectrum as used by the WLAN AP 150. The small cell base station 102′, employing LTE/5G in an unlicensed frequency spectrum, may boost coverage to and/or increase capacity of the access network. LTE in an unlicensed spectrum may be referred to as LTE-unlicensed (LTE-U), licensed assisted access (LAA), or MulteFire.

The wireless communications system 100 may further include a millimeter wave (mmW) base station 180 that may operate in mmW frequencies and/or near mmW frequencies in communication with a UE 182. Extremely high frequency (EHF) is part of the RF in the electromagnetic spectrum. EHF has a range of 30 GHz to 300 GHz and a wavelength between 1 millimeter and 10 millimeters. Radio waves in this band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW/near mmW radio frequency band have high path loss and a relatively short range. The mmW base station 180 and the UE 182 may utilize beamforming (transmit and/or receive) over a mmW communication link 184 to compensate for the extremely high path loss and short range. Further, it will be appreciated that in alternative configurations, one or more base stations 102 may also transmit using mmW or near mmW and beamforming. Accordingly, it will be appreciated that the foregoing illustrations are merely examples and should not be construed to limit the various aspects disclosed herein.

Transmit beamforming is a technique for focusing an RF signal in a specific direction. Traditionally, when a network node (e.g., a base station) broadcasts an RF signal, it broadcasts the signal in all directions (omni-directionally). With transmit beamforming, the network node determines where a given target device (e.g., a UE) is located (relative to the transmitting network node) and projects a stronger downlink RF signal in that specific direction, thereby providing a faster (in terms of data rate) and stronger RF signal for the receiving device(s). To change the directionality of the RF signal when transmitting, a network node can control the phase and relative amplitude of the RF signal at each of the one or more transmitters that are broadcasting the RF signal. For example, a network node may use an array of antennas (referred to as a “phased array” or an “antenna array”) that creates a beam of RF waves that can be “steered” to point in different directions, without actually moving the antennas. Specifically, the RF current from the transmitter is fed to the individual antennas with the correct phase relationship so that the radio waves from the separate antennas add together to increase the radiation in a desired direction, while cancelling to suppress radiation in undesired directions.

Transmit beams may be quasi-collocated, meaning that they appear to the receiver (e.g., a UE) as having the same parameters, regardless of whether or not the transmitting antennas of the network node themselves are physically collocated. In NR, there are four types of quasi-collocation (QCL) relations. Specifically, a QCL relation of a given type means that certain parameters about a second reference RF signal on a second beam can be derived from information about a source reference RF signal on a source beam. Thus, if the source reference RF signal is QCL Type A, the receiver can use the source reference RF signal to estimate the Doppler shift, Doppler spread, average delay, and delay spread of a second reference RF signal transmitted on the same channel. If the source reference RF signal is QCL Type B, the receiver can use the source reference RF signal to estimate the Doppler shift and Doppler spread of a second reference RF signal transmitted on the same channel. If the source reference RF signal is QCL Type C, the receiver can use the source reference RF signal to estimate the Doppler shift and average delay of a second reference RF signal transmitted on the same channel. If the source reference RF signal is QCL Type D, the receiver can use the source reference RF signal to estimate the spatial receive parameter of a second reference RF signal transmitted on the same channel.

In receive beamforming, the receiver uses a receive beam to amplify RF signals detected on a given channel. For example, the receiver can increase the gain setting and/or adjust the phase setting of an array of antennas in a particular direction to amplify (e.g., to increase the gain level of) the RF signals received from that direction. Thus, when a receiver is said to beamform in a certain direction, it means the beam gain in that direction is high relative to the beam gain along other directions, or the beam gain in that direction is the highest compared to the beam gain in that direction of all other receive beams available to the receiver. This results in a stronger received signal strength (e.g., reference signal received power (RSRP), reference signal received quality (RSRQ), signal-to-interference-plus-noise ratio (SINR), etc.) of the RF signals received from that direction.

Receive beams may be spatially related. A spatial relation means that parameters for a transmit beam for a second reference signal can be derived from information about a receive beam for a first reference signal. For example, a UE may use a particular receive beam to receive a reference downlink reference signal (e.g., synchronization signal block (SSB)) from a base station. The UE can then form a transmit beam for sending an uplink reference signal (e.g., sounding reference signal (SRS)) to that base station based on the parameters of the receive beam.

Note that a “downlink” beam may be either a transmit beam or a receive beam, depending on the entity forming it. For example, if a base station is forming the downlink beam to transmit a reference signal to a UE, the downlink beam is a transmit beam. If the UE is forming the downlink beam, however, it is a receive beam to receive the downlink reference signal. Similarly, an “uplink” beam may be either a transmit beam or a receive beam, depending on the entity forming it. For example, if a base station is forming the uplink beam, it is an uplink receive beam, and if a UE is forming the uplink beam, it is an uplink transmit beam.

In 5G, the frequency spectrum in which wireless nodes (e.g., base stations 102/180, UEs 104/182) operate is divided into multiple frequency ranges, FR1 (from 450 to 6000 MHz), FR2 (from 24250 to 52600 MHz), FR3 (above 52600 MHz), and FR4 (between FR1 and FR2). In a multi-carrier system, such as 5G, one of the carrier frequencies is referred to as the “primary carrier” or “anchor carrier” or “primary serving cell” or “PCell,” and the remaining carrier frequencies are referred to as “secondary carriers” or “secondary serving cells” or “SCells.” In carrier aggregation, the anchor carrier is the carrier operating on the primary frequency (e.g., FR1) utilized by a UE 104/182 and the cell in which the UE 104/182 either performs the initial radio resource control (RRC) connection establishment procedure or initiates the RRC connection re-establishment procedure. The primary carrier carries all common and UE-specific control channels. A secondary carrier is a carrier operating on a second frequency (e.g., FR2) that may be configured once the RRC connection is established between the UE 104 and the anchor carrier and that may be used to provide additional radio resources. The secondary carrier may contain only necessary signaling information and signals, for example, those that are UE-specific may not be present in the secondary carrier, since both primary uplink and downlink carriers are typically UE-specific. This means that different UEs 104/182 in a cell may have different downlink primary carriers. The same is true for the uplink primary carriers. The network is able to change the primary carrier of any UE 104/182 at any time. This is done, for example, to balance the load on different carriers. Because a “serving cell” (whether a PCell or an SCell) corresponds to a carrier frequency/component carrier over which some base station is communicating, the term “cell,” “serving cell,” “component carrier,” “carrier frequency,” and the like can be used interchangeably.

For example, still referring to FIG. 1, one of the frequencies utilized by the macro cell base stations 102 may be an anchor carrier (or “PCell”) and other frequencies utilized by the macro cell base stations 102 and/or the mmW base station 180 may be secondary carriers (“SCells”). The simultaneous transmission and/or reception of multiple carriers enables the UE 104/182 to significantly increase its data transmission and/or reception rates. For example, two 20 MHz aggregated carriers in a multi-carrier system would theoretically lead to a two-fold increase in data rate (i.e., 40 MHz), compared to that attained by a single 20 MHz carrier.

The wireless communications system 100 may further include one or more UEs, such as UE 190, that connects indirectly to one or more communication networks via one or more device-to-device (D2D) peer-to-peer (P2P) links. In the example of FIG. 1, UE 190 has a D2D P2P link 192 with one of the UEs 104 connected to one of the base stations 102 (e.g., through which UE 190 may indirectly obtain cellular connectivity) and a D2D P2P link 194 with WLAN STA 152 connected to the WLAN AP 150 (through which UE 190 may indirectly obtain WLAN-based Internet connectivity). In an example, the D2D P2P links 192 and 194 may be supported with any well-known D2D RAT, such as LTE Direct (LTE-D), WiFi Direct (WiFi-D), Bluetooth®, and so on.

The wireless communications system 100 may further include a UE 164 that may communicate with a macro cell base station 102 over a communication link 120 and/or the mmW base station 180 over a mmW communication link 184. For example, the macro cell base station 102 may support a PCell and one or more SCells for the UE 164 and the mmW base station 180 may support one or more SCells for the UE 164.

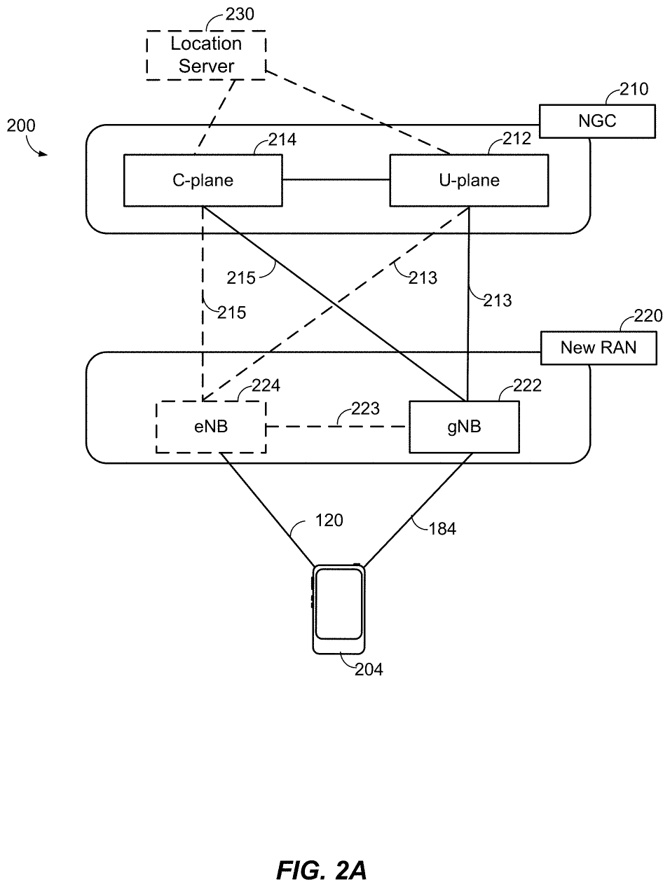

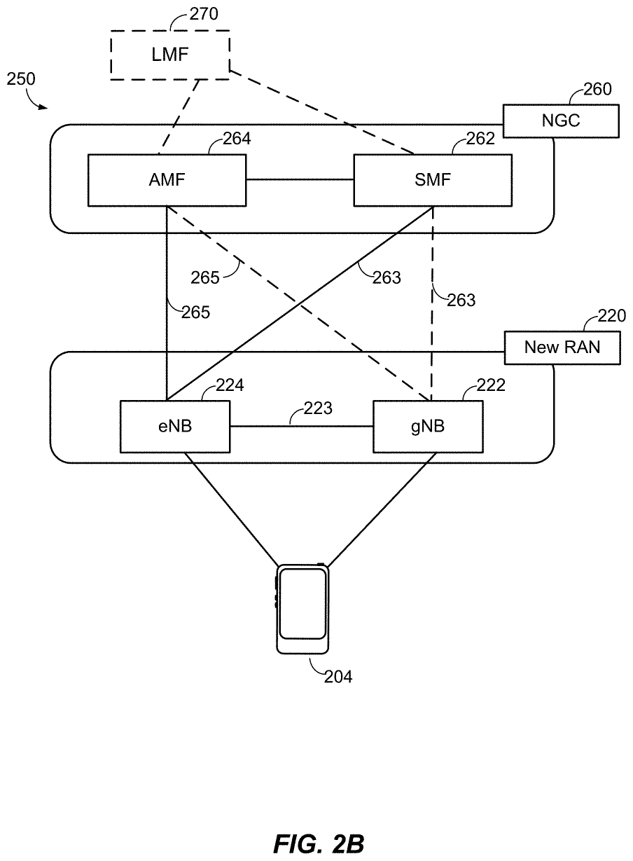

According to various aspects, FIG. 2A illustrates an example wireless network structure 200. For example, an NGC 210 (also referred to as a “5GC”) can be viewed functionally as control plane functions 214 (e.g., UE registration, authentication, network access, gateway selection, etc.) and user plane functions 212, (e.g., UE gateway function, access to data networks, IP routing, etc.) which operate cooperatively to form the core network. User plane interface (NG-U) 213 and control plane interface (NG-C) 215 connect the gNB 222 to the NGC 210 and specifically to the control plane functions 214 and user plane functions 212. In an additional configuration, an eNB 224 may also be connected to the NGC 210 via NG-C 215 to the control plane functions 214 and NG-U 213 to user plane functions 212. Further, eNB 224 may directly communicate with gNB 222 via a backhaul connection 223. In some configurations, the New RAN 220 may only have one or more gNBs 222, while other configurations include one or more of both eNBs 224 and gNBs 222. Either gNB 222 or eNB 224 may communicate with UEs 204 (e.g., any of the UEs depicted in FIG. 1). Another optional aspect may include location server 230, which may be in communication with the NGC 210 to provide location assistance for UEs 204. The location server 230 can be implemented as a plurality of separate servers (e.g., physically separate servers, different software modules on a single server, different software modules spread across multiple physical servers, etc.), or alternately may each correspond to a single server. The location server 230 can be configured to support one or more location services for UEs 204 that can connect to the location server 230 via the core network, NGC 210, and/or via the Internet (not illustrated). Further, the location server 230 may be integrated into a component of the core network, or alternatively may be external to the core network.

According to various aspects, FIG. 2B illustrates another example wireless network structure 250. For example, an NGC 260 (also referred to as a “5GC”) can be viewed functionally as control plane functions, provided by an access and mobility management function (AMF)/user plane function (UPF) 264, and user plane functions, provided by a session management function (SMF) 262, which operate cooperatively to form the core network (i.e., NGC 260). User plane interface 263 and control plane interface 265 connect the eNB 224 to the NGC 260 and specifically to SMF 262 and AMF/UPF 264, respectively. In an additional configuration, a gNB 222 may also be connected to the NGC 260 via control plane interface 265 to AMF/UPF 264 and user plane interface 263 to SMF 262. Further, eNB 224 may directly communicate with gNB 222 via the backhaul connection 223, with or without gNB direct connectivity to the NGC 260. In some configurations, the New RAN 220 may only have one or more gNBs 222, while other configurations include one or more of both eNBs 224 and gNBs 222. Either gNB 222 or eNB 224 may communicate with UEs 204 (e.g., any of the UEs depicted in FIG. 1). The base stations of the New RAN 220 communicate with the AMF-side of the AMF/UPF 264 over the N2 interface and the UPF-side of the AMF/UPF 264 over the N3 interface.

The functions of the AMF include registration management, connection management, reachability management, mobility management, lawful interception, transport for session management (SM) messages between the UE 204 and the SMF 262, transparent proxy services for routing SM messages, access authentication and access authorization, transport for short message service (SMS) messages between the UE 204 and the short message service function (SMSF) (not shown), and security anchor functionality (SEAF). The AMF also interacts with the authentication server function (AUSF) (not shown) and the UE 204, and receives the intermediate key that was established as a result of the UE 204 authentication process. In the case of authentication based on a UMTS (universal mobile telecommunications system) subscriber identity module (USIM), the AMF retrieves the security material from the AUSF. The functions of the AMF also include security context management (SCM). The SCM receives a key from the SEAF that it uses to derive access-network specific keys. The functionality of the AMF also includes location services management for regulatory services, transport for location services messages between the UE 204 and the location management function (LMF) 270, as well as between the New RAN 220 and the LMF 270, evolved packet system (EPS) bearer identifier allocation for interworking with the EPS, and UE 204 mobility event notification. In addition, the AMF also supports functionalities for non-3GPP access networks.

Functions of the UPF include acting as an anchor point for intra-/inter-RAT mobility (when applicable), acting as an external protocol data unit (PDU) session point of interconnect to the data network (not shown), providing packet routing and forwarding, packet inspection, user plane policy rule enforcement (e.g., gating, redirection, traffic steering), lawful interception (user plane collection), traffic usage reporting, quality of service (QoS) handling for the user plane (e.g., UL/DL rate enforcement, reflective QoS marking in the DL), UL traffic verification (service data flow (SDF) to QoS flow mapping), transport level packet marking in the UL and DL, DL packet buffering and DL data notification triggering, and sending and forwarding of one or more “end markers” to the source RAN node.

The functions of the SMF 262 include session management, UE Internet protocol (IP) address allocation and management, selection and control of user plane functions, configuration of traffic steering at the UPF to route traffic to the proper destination, control of part of policy enforcement and QoS, and downlink data notification. The interface over which the SMF 262 communicates with the AMF-side of the AMF/UPF 264 is referred to as the N11 interface.

Another optional aspect may include a LMF 270, which may be in communication with the NGC 260 to provide location assistance for UEs 204. The LMF 270 can be implemented as a plurality of separate servers (e.g., physically separate servers, different software modules on a single server, different software modules spread across multiple physical servers, etc.), or alternately may each correspond to a single server. The LMF 270 can be configured to support one or more location services for UEs 204 that can connect to the LMF 270 via the core network, NGC 260, and/or via the Internet (not illustrated).

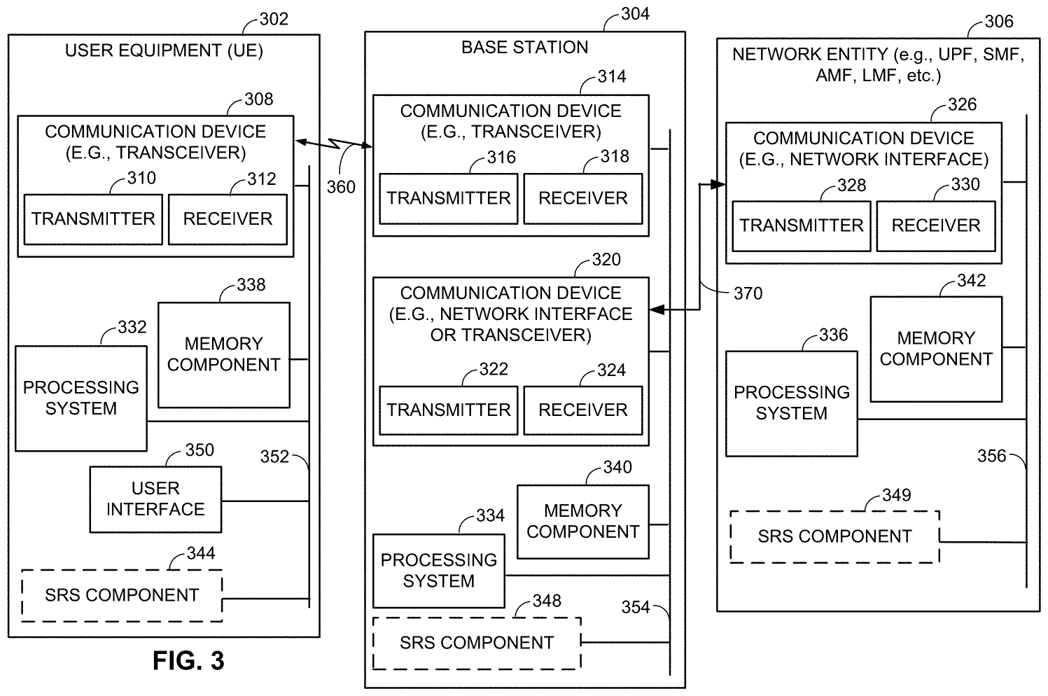

FIG. 3 illustrates several sample components (represented by corresponding blocks) that may be incorporated into a UE 302 (which may correspond to any of the UEs described herein), a base station 304 (which may correspond to any of the base stations described herein), and a network entity 306 (which may correspond to or embody any of the network functions described herein, including the location server 230 and the LMF 270) to support the file transmission operations as taught herein. It will be appreciated that these components may be implemented in different types of apparatuses in different implementations (e.g., in an ASIC, in a system-on-chip (SoC), etc.). The illustrated components may also be incorporated into other apparatuses in a communication system. For example, other apparatuses in a system may include components similar to those described to provide similar functionality. Also, a given apparatus may contain one or more of the components. For example, an apparatus may include multiple transceiver components that enable the apparatus to operate on multiple carriers and/or communicate via different technologies.

The UE 302 and the base station 304 each include at least one wireless communication device (represented by the communication devices 308 and 314 (and the communication device 320 if the apparatus 304 is a relay)) for communicating with other nodes via at least one designated RAT. For example, the communication devices 308 and 314 may communicate with each other over a wireless communication link 360, which may correspond to a communication link 120 in FIG. 1. Each communication device 308 includes at least one transmitter (represented by the transmitter 310) for transmitting and encoding signals (e.g., messages, indications, information, and so on) and at least one receiver (represented by the receiver 312) for receiving and decoding signals (e.g., messages, indications, information, pilots, and so on). Similarly, each communication device 314 includes at least one transmitter (represented by the transmitter 316) for transmitting signals (e.g., messages, indications, information, pilots, and so on) and at least one receiver (represented by the receiver 318) for receiving signals (e.g., messages, indications, information, and so on). If the base station 304 is a relay station, each communication device 320 may include at least one transmitter (represented by the transmitter 322) for transmitting signals (e.g., messages, indications, information, pilots, and so on) and at least one receiver (represented by the receiver 324) for receiving signals (e.g., messages, indications, information, and so on).

A transmitter and a receiver may comprise an integrated device (e.g., embodied as a transmitter circuit and a receiver circuit of a single communication device, generally referred to as a “transceiver”) in some implementations, may comprise a separate transmitter device and a separate receiver device in some implementations, or may be embodied in other ways in other implementations. A wireless communication device (e.g., one of multiple wireless communication devices) of the base station 304 may also comprise a network listen module (NLM) or the like for performing various measurements.

The network entity 306 (and the base station 304 if it is not a relay station) includes at least one communication device (represented by the communication device 326 and, optionally, 320) for communicating with other nodes. For example, the communication device 326 may comprise a network interface that is configured to communicate with one or more network entities via a wire-based or wireless backhaul 370 (which may correspond to the backhaul link 122 in FIG. 1). In some aspects, the communication device 326 may be implemented as a transceiver configured to support wire-based or wireless signal communication, and the transmitter 328 and receiver 330 may be an integrated unit. This communication may involve, for example, sending and receiving: messages, parameters, or other types of information. Accordingly, in the example of FIG. 3, the communication device 326 is shown as comprising a transmitter 328 and a receiver 330. Alternatively, the transmitter 328 and receiver 330 may be separate devices within the communication device 326. Similarly, if the base station 304 is not a relay station, the communication device 320 may comprise a network interface that is configured to communicate with one or more network entities 306 via a wire-based or wireless backhaul 370. As with the communication device 326, the communication device 320 is shown as comprising a transmitter 322 and a receiver 324.

The apparatuses 302, 304, and 306 also include other components that may be used in conjunction with the file transmission operations as disclosed herein. The UE 302 includes a processing system 332 for providing functionality relating to, for example, the UE operations as described herein and for providing other processing functionality. The base station 304 includes a processing system 334 for providing functionality relating to, for example, the base station operations described herein and for providing other processing functionality. The network entity 306 includes a processing system 336 for providing functionality relating to, for example, the network function operations described herein and for providing other processing functionality. The apparatuses 302, 304, and 306 include memory components 338, 340, and 342 (e.g., each including a memory device), respectively, for maintaining information (e.g., information indicative of reserved resources, thresholds, parameters, and so on). In addition, the UE 302 includes a user interface 350 for providing indications (e.g., audible and/or visual indications) to a user and/or for receiving user input (e.g., upon user actuation of a sensing device such a keypad, a touch screen, a microphone, and so on). Although not shown, the apparatuses 304 and 306 may also include user interfaces.

Referring to the processing system 334 in more detail, in the downlink, IP packets from the network entity 306 may be provided to the processing system 334. The processing system 334 may implement functionality for a radio resource control (RRC) layer, a packet data convergence protocol (PDCP) layer, a radio link control (RLC) layer, and a medium access control (MAC) layer. The processing system 334 may provide RRC layer functionality associated with broadcasting of system information (e.g., master information block (MIB), system information blocks (SIBs)), RRC connection control (e.g., RRC connection paging, RRC connection establishment, RRC connection modification, and RRC connection release), inter-RAT mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, scheduling information reporting, error correction, priority handling, and logical channel prioritization.

The transmitter 316 and the receiver 318 may implement Layer-1 functionality associated with various signal processing functions. Layer-1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The transmitter 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an orthogonal frequency division multiplexing (OFDM) subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator may be used to determine the coding and modulation scheme, as well as for spatial processing. The channel estimate may be derived from a reference signal and/or channel condition feedback transmitted by the UE 302. Each spatial stream may then be provided to one or more different antennas. The transmitter 316 may modulate an RF carrier with a respective spatial stream for transmission.

At the UE 302, the receiver 312 receives a signal through its respective antenna(s). The receiver 312 recovers information modulated onto an RF carrier and provides the information to the processing system 332. The transmitter 310 and the receiver 312 implement Layer-1 functionality associated with various signal processing functions. The receiver 312 may perform spatial processing on the information to recover any spatial streams destined for the UE 302. If multiple spatial streams are destined for the UE 302, they may be combined by the receiver 312 into a single OFDM symbol stream. The receiver 312 then converts the OFDM symbol stream from the time-domain to the frequency domain using a fast Fourier transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 304. These soft decisions may be based on channel estimates computed by a channel estimator. The soft decisions are then decoded and de-interleaved to recover the data and control signals that were originally transmitted by the base station 304 on the physical channel. The data and control signals are then provided to the processing system 332, which implements Layer-3 and Layer-2 functionality.

In the UL, the processing system 332 provides demultiplexing between transport and logical channels, packet reassembly, deciphering, header decompression, and control signal processing to recover IP packets from the core network. The processing system 332 is also responsible for error detection.

Similar to the functionality described in connection with the DL transmission by the base station 304, the processing system 332 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

Channel estimates derived by the channel estimator from a reference signal or feedback transmitted by the base station 304 may be used by the transmitter 310 to select the appropriate coding and modulation schemes, and to facilitate spatial processing. The spatial streams generated by the transmitter 310 may be provided to different antenna(s). The transmitter 310 may modulate an RF carrier with a respective spatial stream for transmission.

The UL transmission is processed at the base station 304 in a manner similar to that described in connection with the receiver function at the UE 302. The receiver 318 receives a signal through its respective antenna(s). The receiver 318 recovers information modulated onto an RF carrier and provides the information to the processing system 334.

In the UL, the processing system 334 provides demultiplexing between transport and logical channels, packet reassembly, deciphering, header decompression, control signal processing to recover IP packets from the UE 302. IP packets from the processing system 334 may be provided to the core network. The processing system 334 is also responsible for error detection.

In an aspect, the apparatuses 302, 304 and 306 may include sounding reference signal (SRS) components 344, 348 and 349, respectively. It will be appreciated the functionality of the various SRS components 344, 348 and 349 may differ based on the device where it is being implemented. The SRS components 344, 348 and 349 may be hardware circuits that are part of or coupled to the processing systems 332, 334, and 336, respectively, that, when executed, cause the apparatuses 302, 304, and 306 to perform the functionality described herein. Alternatively, the SRS components 344, 348 and 349 may be memory modules stored in the memory components 338, 340, and 342, respectively, that, when executed by the processing systems 332, 334, and 336, cause the apparatuses 302, 304, and 306 to perform the functionality described herein.

For convenience, the apparatuses 302, 304, and/or 306 are shown in FIG. 3 as including various components that may be configured according to the various examples described herein. It will be appreciated, however, that the illustrated blocks may have different functionality in different designs.

The various components of the apparatuses 302, 304, and 306 may communicate with each other over data buses 352, 354, and 356, respectively. The components of FIG. 3 may be implemented in various ways. In some implementations, the components of FIG. 3 may be implemented in one or more circuits such as, for example, one or more processors and/or one or more ASICs (which may include one or more processors). Here, each circuit may use and/or incorporate at least one memory component for storing information or executable code used by the circuit to provide this functionality. For example, some or all of the functionality represented by blocks 308, 332, 338, 344, and 350 may be implemented by processor and memory component(s) of the UE 302 (e.g., by execution of appropriate code and/or by appropriate configuration of processor components). Similarly, some or all of the functionality represented by blocks 314, 320, 334, 340, and 348 may be implemented by processor and memory component(s) of the base station 304 (e.g., by execution of appropriate code and/or by appropriate configuration of processor components). Also, some or all of the functionality represented by blocks 326, 336, 342, and 349 may be implemented by processor and memory component(s) of the network entity 306 (e.g., by execution of appropriate code and/or by appropriate configuration of processor components). For simplicity, various operations, acts, and/or functions are described herein as being performed “by a UE,” “by a base station,” “by a positioning entity,” etc. However, as will be appreciated, such operations, acts, and/or functions may actually be performed by specific components or combinations of components of the UE, base station, positioning entity, etc., such as the processing systems 332, 334, 336, the communication devices 308, 314, 326, SRS components 344, 348 and 349, etc.

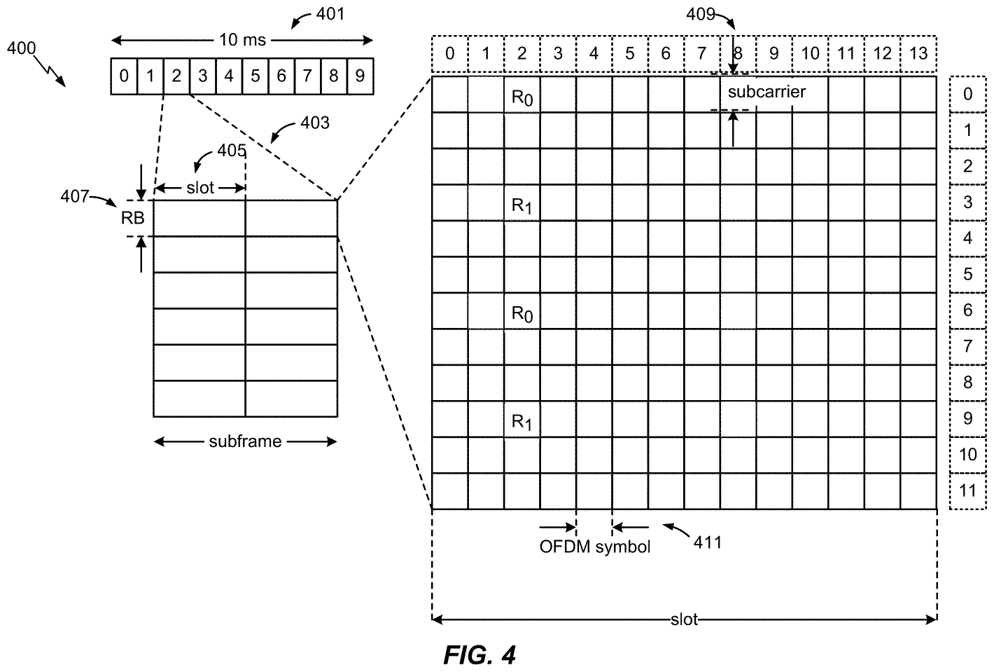

Various frame structures may be used to support downlink and uplink transmissions between network nodes (e.g., base stations and UEs). FIG. 4 illustrates an example of a downlink frame structure 400 according to aspects of the disclosure. However, as those skilled in the art will readily appreciate, the frame structure for any particular application may be different depending on any number of factors. In FIG. 4, time is represented horizontally (e.g., on the X axis) with time increasing from left to right, while frequency is represented vertically (e.g., on the Y axis) with frequency increasing (or decreasing) from bottom to top. In the time domain, a frame 410 (10 ms) is divided into 10 equally sized subframes 420 (1 ms). Each subframe 420 includes two consecutive time slots 430 (0.5 ms).

A resource grid may be used to represent two time slots 430, each time slot 430 including one or more resource blocks (RBs) 440 in the frequency domain (also referred to as “physical resource blocks” or “PRBs”). In LTE, and in some cases NR, a resource block 440 contains 12 consecutive subcarriers 450 in the frequency domain and, for a normal cyclic prefix (CP) in each OFDM symbol 460, 7 consecutive OFDM symbols 460 in the time domain. A resource of one OFDM symbol length in the time domain and one subcarrier in the frequency domain (represented as a block of the resource grid) is referred to as a resource element (RE). As such, in the example of FIG. 4, there are 84 resource elements in a resource block 440.

LTE, and in some cases NR, utilize OFDM on the downlink and single-carrier frequency division multiplexing (SC-FDM) on the uplink. Unlike LTE, however, NR has an option to use OFDM on the uplink as well. OFDM and SC-FDM partition the system bandwidth into multiple (K) orthogonal subcarriers 450, which are also commonly referred to as tones, bins, etc. Each subcarrier 450 may be modulated with data. In general, modulation symbols are sent in the frequency domain with OFDM and in the time domain with SC-FDM. The spacing between adjacent subcarriers 450 may be fixed, and the total number of subcarriers 450 (K) may be dependent on the system bandwidth. For example, the spacing of the subcarriers 450 may be 15 kHz and the minimum resource allocation (resource block) may be 12 subcarriers 450 (or 180 kHz). Consequently, the nominal FFT size may be equal to 128, 256, 512, 1024, or 2048 for system bandwidth of 1.25, 2.5, 5, 10, or 20 megahertz (MHz), respectively. The system bandwidth may also be partitioned into subbands. For example, a subband may cover 1.08 MHz (i.e., 6 resource blocks), and there may be 1, 2, 4, 8, or 16 subbands for system bandwidth of 1.25, 2.5, 5, 10, or 20 MHz, respectively.

LTE supports a single numerology (subcarrier spacing, symbol length, etc.). In contrast NR may support multiple numerologies, for example, subcarrier spacing of 15 kHz, 30 kHz, 60 kHz, 120 kHz and 204 kHz or greater may be available. Table 1 provided below lists some various parameters for different NR numerologies.

TABLE 1

| Subcarrier | | | | | Symbol | Max. nominal |
|---|---|---|---|---|---|---|
| spacing | Symbols / | slots / | slots / | slot | duration | system BW (MHz) |
| (kHz) | slot | subframe | frame | (ms) | (μs) | with 4K FFT size |
| 15 | 14 | 1 | 10 | 1 | 66.7 | 50 |
| 30 | 14 | 2 | 20 | 0.5 | 33.3 | 100 |
| 60 | 14 | 4 | 40 | 0.25 | 16.7 | 100 |
| 120 | 14 | 8 | 80 | 0.125 | 8.33 | 400 |
| 204 | 14 | 16 | 160 | 0.0625 | 4.17 | 800 |

With continued reference to FIG. 4, some of the resource elements, indicated as R₀ and R₁, include a downlink reference signal (DL-RS). The DL-RS may include cell-specific RS (CRS) (also sometimes called common RS) and UE-specific RS (UE-RS). UE-RS are transmitted only on the resource blocks 440 upon which the corresponding physical downlink shared channel (PDSCH) is mapped. The number of bits carried by each resource element depends on the modulation scheme. Thus, the more resource blocks 440 that a UE receives and the higher the modulation scheme, the higher the data rate for the UE.

An SRS is an uplink-only signal that a UE transmits to help the base station obtain the channel state information (CSI) for each user. Channel state information describes how an RF signal propagates from the UE to the base station and represents the combined effect of scattering, fading, and power decay with distance. The system uses the SRS for resource scheduling, link adaptation, massive MIMO, beam management, etc.

On one extreme, the SRS can be used at the gNB simply to obtain signal strength measurements, e.g., for the purposes of UL beam management. On the other extreme, SRS can be used at the gNB to obtain detailed amplitude and phase estimates as a function of frequency, time and space. In NR, channel sounding with SRS supports a more diverse set of use cases compared to LTE (e.g., downlink CSI acquisition for reciprocity-based gNB transmit beamforming (downlink MIMO); uplink CSI acquisition for link adaptation and codebook/non-codebook based precoding for uplink MIMO, uplink beam management, etc.).

The SRS can be configured using various options. In some designs, the time/frequency mapping of an SRS resource is defined by the following characteristics:
Time duration N_{symb}^{SRS}—The time duration of an SRS resource can be 1, 2, or 4 consecutive OFDM symbols within a slot, in contrast to LTE which allows only a single OFDM symbol per slot.
Starting symbol location l₀—The starting symbol of an SRS resource can be located anywhere within the last 6 OFDM symbols of a slot provided the resource does not cross the end-of-slot boundary.
Repetition factor R—For an SRS resource configured with frequency hopping, repetition allows the same set of subcarriers to be sounded in R consecutive OFDM symbols before the next hop occurs (as used herein, a “hop” refers to specifically to a frequency hop). For example, values of R are 1, 2, 4 where R≤N_{symb}^{SRS}.
Transmission comb spacing K_{TC} and comb offset k_{TC}—An SRS resource may occupy resource elements (REs) of a frequency domain comb structure, where the comb spacing is either 2 or 4 REs like in LTE. Such a structure allows frequency domain multiplexing of different SRS resources of the same or different users on different combs, where the different combs are offset from each other by an integer number of REs. The comb offset is defined with respect to a PRB boundary, and can take values in the range 0,1, . . . , K_{TC}−1 REs. Thus, for comb spacing K_{TC}=2, there are 2 different combs available for multiplexing if needed, and for comb spacing K_{TC}=4, there are 4 different available combs.
Periodicity and slot offset for the case of periodic/semi-persistent (SP) SRS.
Sounding bandwidth within a bandwidth part (BWP).

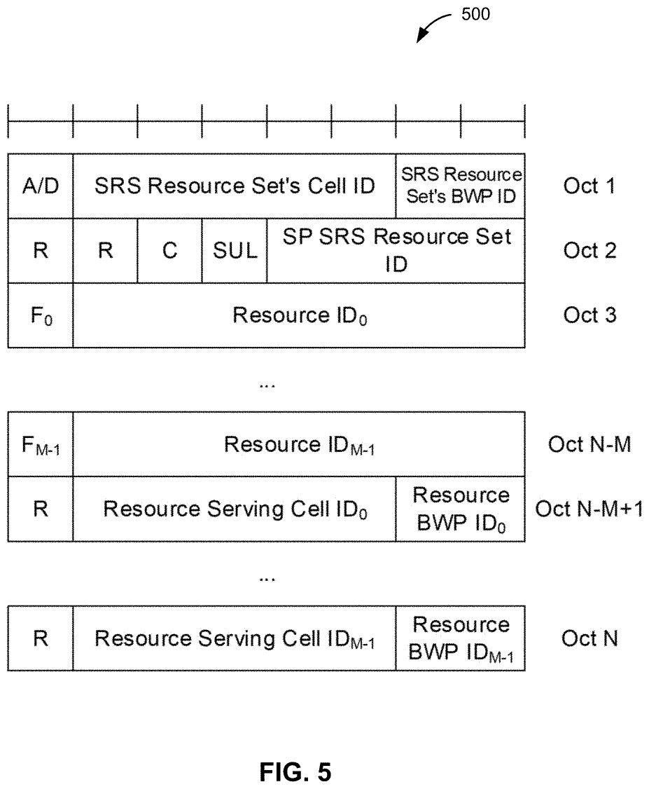

In some designs, a media access control (MAC) command element (CE) may be used to activate or deactivate SRS. FIG. 5 illustrates an example configuration of a Rel. 15 SP SRS Activation/Deactivation MAC CE 500. With respect to the Rel. 15 MAC CE 500 depicted in FIG. 5, the respective fields are defined as follows:
A/D: This field indicates whether to activate or deactivate indicated SP SRS resource set. The field is set to 1 to indicate activation, otherwise it indicates deactivation; SRS Resource Set's Cell ID: This field indicates the identity of the Serving
Cell, which contains activated/deactivated SP SRS Resource Set. If the C field is set to 0, this field also indicates the identity of the Serving Cell which contains all resources indicated by the Resource IDi fields. The length of the field is 5 bits;
SRS Resource Set's BWP ID: This field indicates a UL BWP as the codepoint of the DCI bandwidth part indicator field as specified in TS 38.212 [9], which contains activated/deactivated SP SRS Resource Set. If the C field is set to 0, this field also indicates the identity of the BWP which contains all resources indicated by the Resource IDi fields. The length of the field is 2 bits;
C: This field indicates whether the octets containing Resource Serving Cell ID field(s) and Resource BWP ID field(s) are present. If this field is set to 1, the octets containing Resource Serving Cell ID field(s) and Resource BWP ID field(s) are present, otherwise they are not present;
SUL: This field indicates whether the MAC CE applies to the NUL carrier or SUL carrier configuration. This field is set to 1 to indicate that it applies to the SUL carrier configuration, and it is set to 0 to indicate that it applies to the NUL carrier configuration;
SP SRS Resource Set ID: This field indicates the SP SRS Resource Set ID identified by SRS-ResourceSetld as specified in TS 38.331, which is to be activated or deactivated. The length of the field is 4 bits;
Fi: This field indicates the type of a resource used as a spatial relationship for SRS resource within SP SRS Resource Set indicated with SP SRS Resource Set ID field. F0 refers to the first SRS resource within the resource set, F1 to the second one and so on. The field is set to 1 to indicate NZP CSI-RS resource index is used, and it is set to 0 to indicate either SSB index or SRS resource index is used. The length of the field is 1 bit. This field is only present if MAC CE is used for activation, i.e. the A/D field is set to 1;
Resource IDi: This field contains an identifier of the resource used for spatial relationship derivation for SRS resource i. Resource ID0 refers to the first SRS resource within the resource set, Resource ID1 to the second one and so on. If Fi is set to 0, and the first bit of this field is set to 1, the remainder of this field contains SSB-Index as specified in TS 38.331. If Fi is set to 0, and the first bit of this field is set to 0, the remainder of this field contains SRS-ResourceId as specified in TS 38.331. The length of the field is 7 bits. This field is only present if MAC CE is used for activation, i.e. the A/D field is set to 1;
Resource Serving Cell IDi: This field indicates the identity of the Serving Cell on which the resource used for spatial relationship derivation for SRS resource i is located. The length of the field is 5 bits;
Resource BWP IDi: This field indicates a UL BWP as the codepoint of the DCI bandwidth part indicator field as specified in TS 38.212, on which the resource used for spatial relationship derivation for SRS resource i is located. The length of the field is 2 bits;

The Rel. 15 MAC CE 500 depicted in FIG. 5 only allows spatial relation information to be updated for a single cell. In this case, the network is required to send an individual MAC CE for each component carrier (CC), resulting in a high overhead and large latency impacting the network throughput.

Embodiments of the disclosure are thereby directed to activating (or de-activating) spatial relation information for SRS resources by a MAC CE via an explicit or implicit indication of a list of cells, whereby the spatial relation information is applied with respect to all cells in the list of cells (e.g., in contrast to the Rel. 15 MAC CE 500 depicted in FIG. 5, which by default is applicable to a single cell). This approach provides various technical advantages, such as reducing overhead, as well as reducing latency impacting the network throughput.

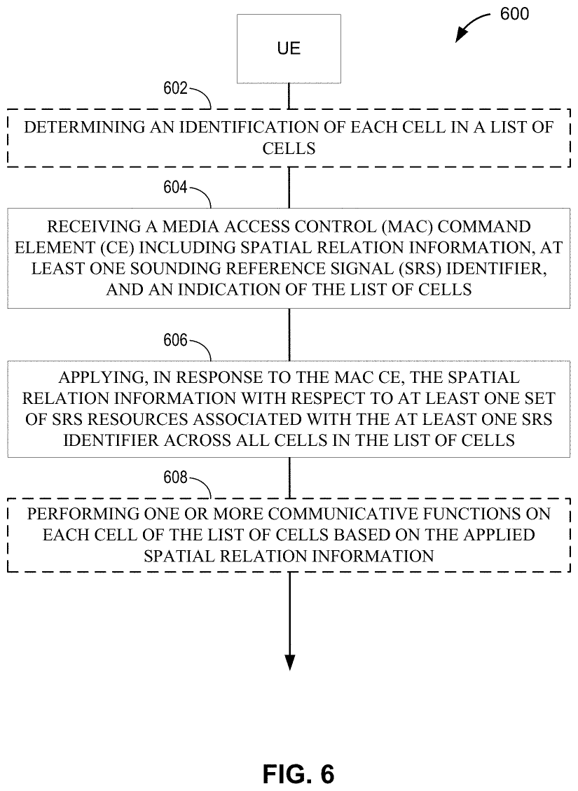

FIG. 6 illustrates an exemplary method 600 of wireless communication, according to aspects of the disclosure. The method 600 may be performed by a UE (e.g., any of the UEs described herein).

At 602, the UE (e.g., receiver 312, processing system 332, SRS component 344, etc.) optionally determines an identification of each cell in a list of cells. In an example, the optional determination of 602 may be based upon higher-layer signaling, such as RRC signaling. In an example, RRC signaling maybe used to configure a cell list parameter which may be denoted as cc_list, which may be identified via a cc_list identifier. In an example, the cc_list can be configured in CellGroupConfig, which is a cell group level parameter instead of cell level parameter. In another example, the cc_list can be a UE level parameter, for example, in ServingCellConfig (e.g., the cells in the list may even cross different cell groups). In another example, the cc_list can be configured as one parameter under the SRS configuration. In some designs, if cc_list is not pre-configured, then the multi-CC update feature for spatial relation information may be disabled (e.g., such that a MAC CE would only trigger an update for a single cell, similar to the legacy Rel. 15 MAC CE 500 depicted in FIG. 5).

At 604, the UE (e.g., receiver 312, etc.) receives a MAC CE including spatial relation information, at least one SRS identifier, and an indication of a list of cells. As will be described below in more detail, the list of cells may comprise a single cell (e.g., in which case the functional result is equivalent to the legacy Rel. 15 MAC CE 500 depicted in FIG. 5), or the list of cells may comprise a plurality of cells. Further, the indication of the list of cells may be explicit (e.g., via reference to a cell list identifier) or implicit (e.g., via reference to a subset of cells that belong to the list, which functions to implicitly indicate the broader list of cells).

At 606, the UE (e.g., transmitter 310, receiver 312, processing system 332, memory component 338, SRS component 344, etc.) applies, in response to the MAC CE from 604, the spatial relation information with respect to at least one set of SRS resources associated with the at least one SRS identifier across all cells in the list of cells. In an example, the at least one set of SRS resources corresponds to at least one set of aperiodic (AP) or semi-persistent (SP) SRS resources. In a more specific example, the at least one set of SRS resources may comprise all AP or SP SRS resources associated with the at least one SRS identifier for all BWPs for each cell in the list of cells. In an example, the MAC CE may comprise a single SRS identifier or multiple SRS identifiers. If the MAC CE may comprises multiple SRS identifiers, then the applying is performed with respect to a respective set of SRS resources for each of the multiple SRS identifiers across all cells in the list of cells.

At 608, the UE (e.g., transmitter 310, receiver 312, processing system 332, memory component 338, SRS component 344, etc.) optionally performs one or more communicative functions on each cell of the list of cells based on the applied spatial relation information. The one or more communicative functions may comprise one or more of a positioning procedure, a transmission, a reception, a timing synchronization procedure, and so on.

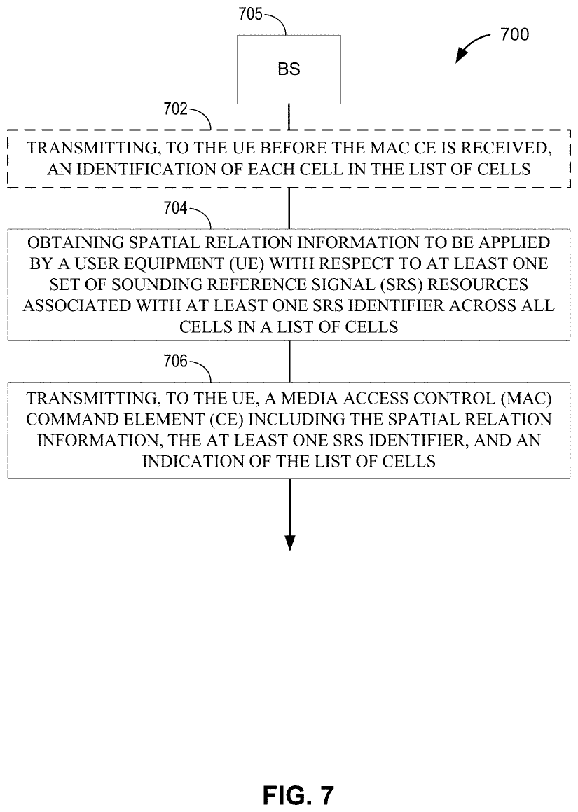

FIG. 7 illustrates an exemplary method 700 of wireless communication, according to aspects of the disclosure. The method 700 may be performed by a BS (e.g., any of the BSs described herein).

At 702, the BS (e.g., transmitter 316, SRS component 344, etc.) optionally transmits, to a UE, an identification of each cell in the list of cells. In an example, the optional transmission of 702 may be based upon higher-layer signaling, such as RRC signaling. In an example, RRC signaling maybe used to configure a cell list parameter which may be denoted as cc_list, as described above with respect to 602 of FIG. 6

At 704, the BS (e.g., network interface 320, memory component 340, processing system 334, SRS component 348, etc.) obtains spatial relation information to be applied by the UE with respect to at least one set of SRS resources associated with at least one SRS identifier across all cells in a list of cells. As will be described below in more detail, the list of cells may comprise a single cell (e.g., in which case the functional result is equivalent to the legacy Rel. 15 MAC CE 500 depicted in FIG. 5), or the list of cells may comprise a plurality of cells. Further, the indication of the list of cells may be explicit (e.g., via reference to a cell list identifier) or implicit (e.g., via reference to a subset of cells that belong to the list, which functions to implicitly indicate the broader list of cells).

At 706, the BS (e.g., transmitter 316, SRS component 344, etc.) transmits, to the UE, a MAC CE including the spatial relation information, the at least one SRS identifier, and an indication of the list of cells. In an example, the at least one set of SRS resources corresponds to at least one set of AP or SP SRS resources. In a more specific example, the at least one set of SRS resources may comprise all AP or SP SRS resources associated with the at least one SRS identifier for all BWPs for each cell in the list of cells. In an example, the MAC CE may comprise a single SRS identifier or multiple SRS identifiers. If the MAC CE may comprises multiple SRS identifiers, then the spatial relation information with respect to a respective set of SRS resources for each of the multiple SRS identifiers across all cells in the list of cells.

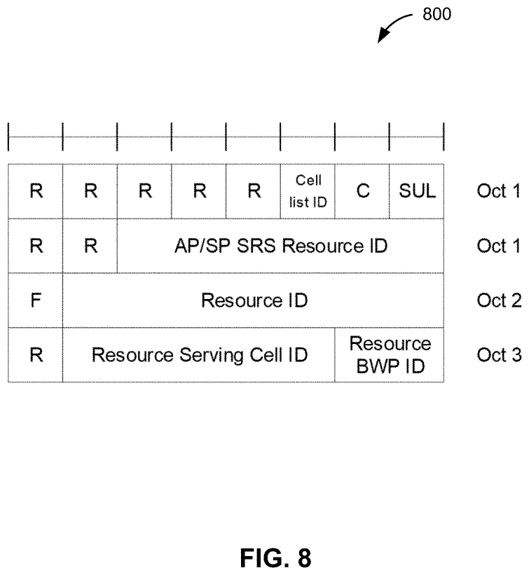

FIG. 8 illustrates an example configuration of a SRS Activation/Deactivation MAC CE 800 in accordance with an embodiment of the disclosure. The MAC CE 800 is an example of a MAC CE that may be used in the process 600 of FIG. 6 or the process 700 of FIG. 7. Some fields (e.g., C, SUL, etc.) are configured in the same manner as described above with respect to the Rel. 15 SP SRS Activation/Deactivation MAC CE 500 depicted in FIG. 5, and as such will not be described further for the sake of brevity. The MAC CE 800 is an example where an explicit indication of the list of cells is provided via a cell list identifier, denoted as Cell list ID. Further, the MAC CE 800 includes a single AP/SP SRS resource ID. Accordingly, in some designs, a UE receiving the MAC CE 800 may apply the spatial relation information with respect to a set of SRS resources associated with the single SRS identifier across all cells in the list of cells.

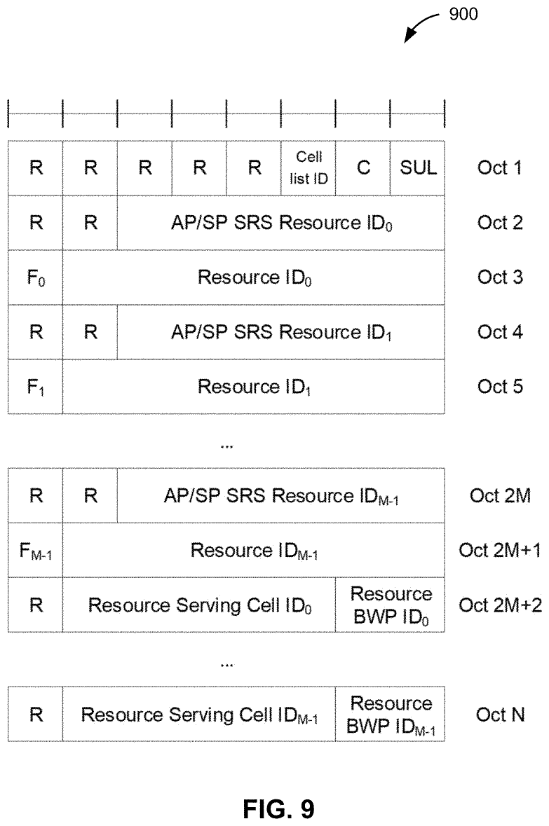

FIG. 9 illustrates an example configuration of a SRS Activation/Deactivation MAC CE 900 in accordance with another embodiment of the disclosure. The MAC CE 900 is another example of a MAC CE that may be used in the process 600 of FIG. 6 or the process 700 of FIG. 7. Some fields (e.g., C, SUL, etc.) are configured in the same manner as described above with respect to the Rel. 15 SP SRS Activation/Deactivation MAC CE 500 depicted in FIG. 5, and as such will not be described further for the sake of brevity. The MAC CE 900 is an example where an explicit indication of the list of cells is provided via a cell list identifier, denoted as Cell list ID. Further, the MAC CE 900 includes a plurality (M) of AP/SP SRS resource IDs, denoted as AP/SP SRS ID₀ . . . ID_{M-1}. Accordingly, in some designs, a UE receiving the MAC CE 900 may apply the spatial relation information with respect to a set of SRS resources associated with each of the M AP/SP SRS resource IDs across all the BWPs of all cells in the list of cells.

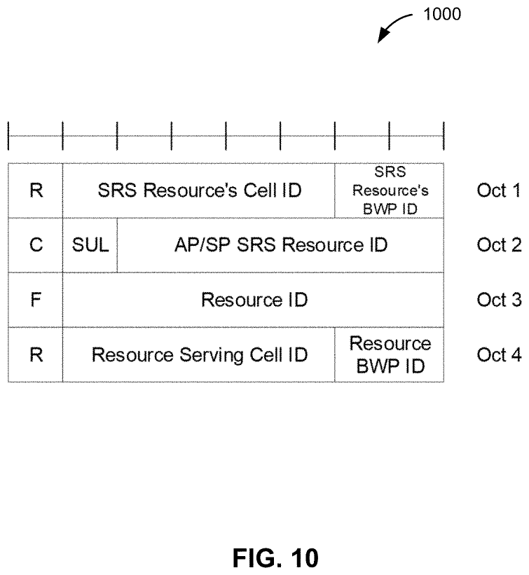

FIG. 10 illustrates an example configuration of a SRS Activation/Deactivation MAC CE 1000 in accordance with an embodiment of the disclosure. The MAC CE 1000 is an example of a MAC CE that may be used in the process 600 of FIG. 6 or the process 700 of FIG. 7. Some fields (e.g., C, SUL, etc.) are configured in the same manner as described above with respect to the Rel. 15 SP SRS Activation/Deactivation MAC CE 500 depicted in FIG. 5, and as such will not be described further for the sake of brevity. The MAC CE 1000 is an example where an implicit indication of the list of cells is provided without explicit reference to a cell list identifier. In particular, the MAC CE 1000 specifies a single SRS Resource Cell ID. In some designs, this single SRS Resource Cell ID belongs to a list of cells, and in this case represents the list of cells rather than just its own cell. Further, the MAC CE 1000 includes a single AP/SP SRS resource ID. Accordingly, in some designs, a UE receiving the MAC CE 1000 may apply the spatial relation information with respect to a set of SRS resources associated with the single SRS identifier across all the BWPs of all cells in the list of cells, even though the MAC CE 1000 only expressly identifies a single SRS Resource Cell ID from that list of cells. However, if no list of cells including the single SRS Resource Cell ID is configured with the UE, then the UE will apply the spatial relation information with respect to a set of SRS resources associated with the single SRS identifier across only the cell associated with that single SRS identifier.

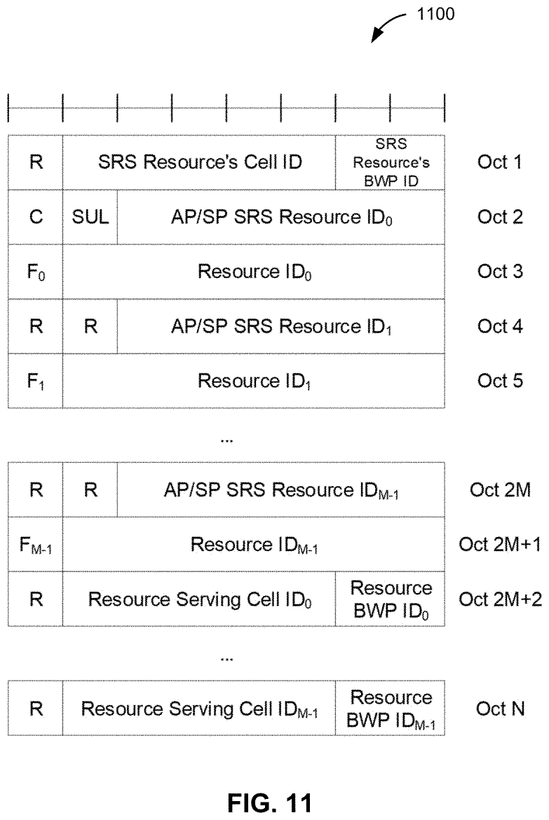

FIG. 11 illustrates an example configuration of a SRS Activation/Deactivation MAC CE 1100 in accordance with another embodiment of the disclosure. The MAC CE 1100 is another example of a MAC CE that may be used in the process 600 of FIG. 6 or the process 700 of FIG. 7. Some fields (e.g., C, SUL, etc.) are configured in the same manner as described above with respect to the Rel. 15 SP SRS Activation/Deactivation MAC CE 500 depicted in FIG. 5, and as such will not be described further for the sake of brevity. The MAC CE 1100 is an example where an implicit indication of the list of cells is provided without explicit reference to a cell list identifier. In particular, the MAC CE 1100 specifies a single SRS Resource Cell ID. In some designs, this single SRS Resource Cell ID belongs to a list of cells, and in this case represents the list of cells rather than just its own cell. Further, the MAC CE 1100 includes a plurality (M) of AP/SP SRS resource IDs, denoted as AP/SP SRS ID₀ . . . ID_{M-1}. Accordingly, in some designs, a UE receiving the MAC CE 900 may apply the spatial relation information with respect to a set of SRS resources associated with each of the M AP/SP SRS resource IDs across all cells in the list of cells, even though the MAC CE 1100 only expressly identifies a single SRS Resource Cell ID from that list of cells. However, if no list of cells including the single SRS Resource Cell ID is configured with the UE, then the UE will apply the spatial relation information with respect to a set of SRS resources associated with the single SRS identifier across only the cell associated with that single SRS identifier.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a general purpose processor, a DSP, an ASIC, an FPGA, or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The methods, sequences and/or algorithms described in connection with the aspects disclosed herein may be embodied directly in hardware, in a software module executed by a processor, or in a combination of the two. A software module may reside in random access memory (RAM), flash memory, read-only memory (ROM), erasable programmable ROM (EPROM), electrically erasable programmable ROM (EEPROM), registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal (e.g., UE). In the alternative, the processor and the storage medium may reside as discrete components in a user terminal.

In one or more exemplary aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

While the foregoing disclosure shows illustrative aspects of the disclosure, it should be noted that various changes and modifications could be made herein without departing from the scope of the disclosure as defined by the appended claims. The functions, steps and/or actions of the method claims in accordance with the aspects of the disclosure described herein need not be performed in any particular order. Furthermore, although elements of the disclosure may be described or claimed in the singular, the plural is contemplated unless limitation to the singular is explicitly stated.

A complete listing of the claims, including current amendments (if any), is as follows:

1. A method of operating a user equipment (UE), comprising:
receiving a media access control (MAC) command element (CE) including spatial relation information, at least one sounding reference signal (SRS) identifier, and an indication of a list of cells; and
applying, in response to the MAC CE, the spatial relation information with respect to at least one set of SRS resources associated with the at least one SRS identifier across all cells in the list of cells.

2. The method of claim 1, further comprising:
determining, before the MAC CE is received, an identification of each cell in the list of cells.

3. The method of claim 2, wherein the determining is based on a cell group level parameter, a UE level parameter, or an SRS configuration parameter.

4. The method of claim 1,
wherein the list of cells comprises a single cell, or
wherein the list of cells comprises a plurality of cells.

5. The method of claim 1, wherein the list of cells is expressly identified within the MAC CE via a cell list identifier.

6. The method of claim 5,
wherein the list of cells comprises a plurality of cells, and
wherein each of the plurality of cells is indicated via the cell list identifier.

7. The method of claim 1, wherein the list of cells is implicitly indicated within the MAC CE.

8. The method of claim 7,
wherein the list of cells comprises a plurality of cells,
wherein the MAC CE expressly identifies a subset of the plurality of cells, and
wherein the UE interprets the express identification of the subset of the plurality of cells as an implicit reference to the plurality of cells.

9. The method of claim 8, wherein the expressly identified subset includes a single cell.

10. The method of claim 1, wherein the MAC CE comprises a single SRS identifier.

11. The method of claim 1,
wherein the MAC CE comprises multiple SRS identifiers, and
wherein the applying is performed with respect to a respective set of SRS resources for each of the multiple SRS identifiers across all cells in the list of cells.

12. The method of claim 1, wherein the at least one set of SRS resources corresponds to at least one set of aperiodic (AP) or semi-persistent (SP) SRS resources.

13. The method of claim 12, wherein the at least one set of SRS resources comprises all AP or SP SRS resources associated with the at least one SRS identifier for all BWPs for each cell in the list of cells.

14. The method of claim 1, further comprising:
performing one or more communicative functions on each cell of the list of cells based on the applied spatial relation information.

15. A method of operating a network component, comprising:
obtaining spatial relation information to be applied by a user equipment (UE) with respect to at least one set of sounding reference signal (SRS) resources associated with at least one SRS identifier across all cells in a list of cells; and
transmitting, to the UE, a media access control (MAC) command element (CE) including the spatial relation information, the at least one SRS identifier, and an indication of the list of cells.

16. The method of claim 1, further comprising:
transmitting, to the UE before the MAC CE is received, an identification of each cell in the list of cells.

17. The method of claim 16, wherein the determining is based on a cell group level parameter, a UE level parameter, or an SRS configuration parameter.

18. The method of claim 15,
wherein the list of cells comprises a single cell, or
wherein the list of cells comprises a plurality of cells.

19. The method of claim 15, wherein the list of cells is expressly identified within the MAC CE via a cell list identifier.

20. The method of claim 19,
wherein the list of cells comprises a plurality of cells, and
wherein each of the plurality of cells is indicated via the cell list identifier.

21. The method of claim 15, wherein the list of cells is implicitly indicated within the MAC CE.

22. The method of claim 21,
wherein the list of cells comprises a plurality of cells,
wherein the MAC CE expressly identifies a subset of the plurality of cells, and
wherein the express identification of the subset of the plurality of cells is configured to implicitly reference the plurality of cells to the UE.

23. The method of claim 22, wherein the expressly identified subset includes a single cell.

24. The method of claim 15, wherein the MAC CE comprises a single SRS identifier.

25. The method of claim 15,
wherein the MAC CE comprises multiple SRS identifiers, and
wherein the spatial relation information is configured to be applied by the UE with respect to a respective set of SRS resources for each of the multiple SRS identifiers across all cells in the list of cells.

26. The method of claim 15, wherein the at least one set of SRS resources corresponds to at least one set of aperiodic (AP) or semi-persistent (SP) SRS resources.

27. The method of claim 26, wherein the at least one set of SRS resources comprises all AP or SP SRS resources associated with the at least one SRS identifier for all BWPs for each cell in the list of cells.

28. (canceled)

29. (canceled)

30. A user equipment (UE), comprising:
a memory;
at least one communications interface; and
at least one processor communicatively coupled to the memory, the at least one communications interface, the at least one processor configured to:
receive a media access control (MAC) command element (CE) including spatial relation information, at least one sounding reference signal (SRS) identifier, and an indication of a list of cells; and
apply, in response to the MAC CE, the spatial relation information with respect to at least one set of SRS resources associated with the at least one SRS identifier across all cells in the list of cells.

31. A network component, comprising:
a memory;
at least one communications interface; and
at least one processor communicatively coupled to the memory, the at least one communications interface, the at least one processor configured to:
obtain spatial relation information to be applied by a user equipment (UE) with respect to at least one set of sounding reference signal (SRS) resources associated with at least one SRS identifier across all cells in a list of cells; and
transmit, to the UE, a media access control (MAC) command element (CE) including the spatial relation information, the at least one SRS identifier, and an indication of the list of cells

32. (canceled)

33. (canceled)

34. The method of claim 15, wherein the network component corresponds to a base station.
